(19) United States
(12) Patent Application Publication
(10) Pub. No.: US 2020/0049091 A1
(43) Pub. Date: Feb. 13, 2020

(54) OXYGEN SENSOR DIAGNOSTIC

(71) Applicant: GM Global Technology Operations LLC, Detroit, MI (US)

(72) Inventors: Junhong Dai, Rochester Hills, MI (US); Douglas Dickson, White Lake, MI (US); John W. Siekkinen, Novi, MI (US); Jerry J. Sheahan, Canton, MI (US); Jeffry A. Helmick, Oxford, MI (US)

(21) Appl. No.: 16/057,332

(22) Filed: Aug. 7, 2018

(51) Int. Cl. F02D 41/14; F02D 41/30; F02D 41/26; G01M 15/10

(52) U.S. Cl. CPC F02D 41/1495; F02D 41/30; F02D 41/26; F02D 2200/501; F02D 2200/602; F02D 2200/0614; G01M 15/104

(57) ABSTRACT

According to one or more embodiments of the technical solutions described herein, a control system in a motor vehicle that includes an internal combustion engine includes an oxygen sensor, and an oxygen sensor diagnosis module to diagnose the oxygen sensor. The oxygen sensor diagnosis includes performing an intrusive rich-to-lean diagnostic for the oxygen sensor, and detecting a lean-to-rich diagnostic event. In response, the diagnosis includes performing a passive lean-to-rich diagnostic for the oxygen sensor, the lean-to-rich diagnostic event comprising a fuel enrichment.

The present disclosure relates to an oxygen sensor diagnostic techniques, and in particular to diagnosing oxygen sensors used for controlling operation of an internal combustion engine.

Electronic engine controls for internal combustion engines are known. Such controls can control various aspects of engine operations such as controlling air flow rate, air fuel ratio, spark advance, fuel injection timing and more complex transition phases between engine start and engine running. Such sensors measure air flow rate and oxygen concentration in the exhaust flow. Further, such systems are capable of performing on board diagnostic processes for the various sensors used in sensing engine operating parameters.

### SUMMARY

According to one or more embodiments of the technical solutions described herein, a control system in a motor vehicle that includes an internal combustion engine includes an oxygen sensor, and an oxygen sensor diagnosis module to diagnose the oxygen sensor. The oxygen sensor diagnosis includes performing an intrusive rich-to-lean diagnostic for the oxygen sensor, and detecting a lean-to-rich diagnostic event. In response, the diagnosis includes performing a passive lean-to-rich diagnostic for the oxygen sensor, the lean-to-rich diagnostic event comprising a fuel enrichment.

In one or more examples, the lean-to-rich event is caused by a catalyst oxygen storage control for a catalyst in an exhaust system of the internal combustion engine. Alternatively, or in addition, the lean-to-rich event is caused by at least one event from a group of events comprising an accelerator pedal being pushed by an operator of the motor vehicle, an automated increased torque request, and the engine exiting a deceleration fuel cut-off condition.

In one or more examples, the passive lean-to-rich diagnostic further includes determining an amount of fuel injected during the lean-to-rich event. In response to the amount of fuel being less than or equal to a predetermined threshold, injecting an additional amount of fuel to at least meet the predetermined threshold. The intrusive rich-to-lean diagnostic is performed when a first deceleration of the motor vehicle is detected, and the passive lean-to-rich diagnostic is performed when a second deceleration of the motor vehicle is detected.

In one or more examples, the oxygen sensor is upstream of a catalyst in an exhaust system of the motor vehicle. Alternatively, or in addition, the oxygen sensor is downstream of a catalyst in an exhaust system of the motor vehicle.

According to one or more embodiments, an on-board oxygen sensor diagnostic apparatus for an internal combustion engine includes a controller to diagnose one or more oxygen sensors. The oxygen sensor diagnosis includes performing an intrusive rich-to-lean diagnostic for the oxygen sensor, and detecting a lean-to-rich diagnostic event. In response, the diagnosis includes performing a passive lean-to-rich diagnostic for the oxygen sensor, the lean-to-rich diagnostic event comprising a fuel enrichment.

In one or more examples, the lean-to-rich event is caused by a catalyst oxygen storage control for a catalyst in an exhaust system of the internal combustion engine. Alternatively, or in addition, the lean-to-rich event is caused by at least one event from a group of events comprising an accelerator pedal being pushed by an operator of the motor vehicle, an automated increased torque request, and the engine exiting a deceleration fuel cut-off condition.

In one or more examples, the passive lean-to-rich diagnostic further includes determining an amount of fuel injected during the lean-to-rich event. In response to the amount of fuel being less than or equal to a predetermined threshold, injecting an additional amount of fuel to at least meet the predetermined threshold. The intrusive rich-to-lean diagnostic is performed when a first deceleration of the motor vehicle is detected, and the passive lean-to-rich diagnostic is performed when a second deceleration of the motor vehicle is detected.

In one or more examples, the oxygen sensor is upstream of a catalyst in an exhaust system of the motor vehicle. Alternatively, or in addition, the oxygen sensor is downstream of a catalyst in an exhaust system of the motor vehicle.

According to one or more embodiments, a computer-implemented method for diagnosing one or more oxygen sensors in an exhaust system of an internal combustion engine in a motor vehicle includes performing an intrusive rich-to-lean diagnostic for the oxygen sensor. The method further includes detecting a lean-to-rich diagnostic event, and in response, performing a passive lean-to-rich diagnostic for the oxygen sensor, the lean-to-rich diagnostic event comprising a fuel enrichment.

In one or more examples, the lean-to-rich event is caused by a catalyst oxygen storage control for a catalyst in an exhaust system of the internal combustion engine. Alternatively, or in addition, the lean-to-rich event is caused by at least one event from a group of events comprising an accelerator pedal being pushed by an operator of the motor vehicle, an automated increased torque request, and the engine exiting a deceleration fuel cut-off condition.

In one or more examples, the passive lean-to-rich diagnostic further includes determining an amount of fuel injected during the lean-to-rich event. In response to the amount of fuel being less than or equal to a predetermined threshold, injecting an additional amount of fuel to at least meet the predetermined threshold. The intrusive rich-to-lean diagnostic is performed when a first deceleration of the motor vehicle is detected, and the passive lean-to-rich diagnostic is performed when a second deceleration of the motor vehicle is detected.

In one or more examples, the oxygen sensor is upstream of a catalyst in an exhaust system of the motor vehicle. Alternatively, or in addition, the oxygen sensor is downstream of a catalyst in an exhaust system of the motor vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a block diagram of an exemplary motor vehicle;

FIG. 2 depicts an oxygen sensor diagnostic that includes two intrusive test events, a first intrusive test and a second intrusive test;

FIG. 3 depicts an oxygen sensor diagnostic according to one or more embodiments that includes a first intrusive test and a second passive (non-intrusive) test; and

FIG. 4A and FIG. 4B depict a flowchart of a method for performing oxygen sensor diagnostic according to one or more embodiments, the diagnostic including a first intrusive test and a second passive (non-intrusive) test.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory module that executes one or more software or firmware programs, a combinational logic circuit, and/or other suitable components that provide the described functionality.

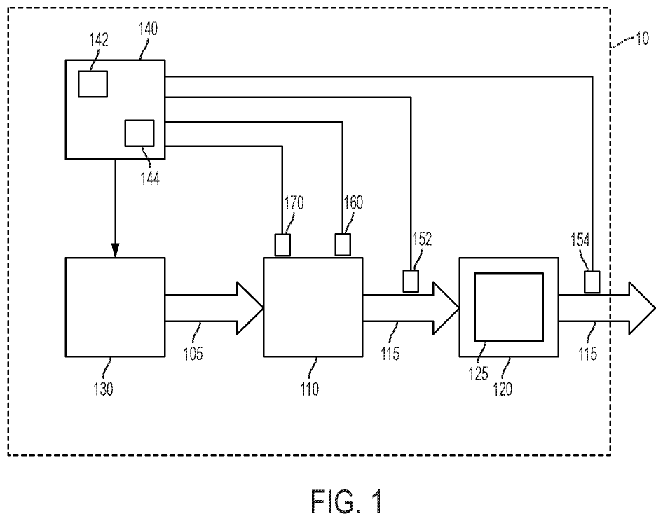

FIG. 1 depicts a block diagram of an exemplary motor vehicle 10. The vehicle 10 includes an internal combustion engine (engine) 110, and an exhaust system 120 that includes a catalyst device 125. The vehicle 10 further includes one or more actuators 130 that are controlled by a processing unit 140 that can include one or more electronic control units (ECU). The processing unit 140 is responsible for controlling the operation of the engine 110, such as the amount of power generated by the engine 110. The processing unit 140 includes a closed loop fuel control module 142 and an oxygen sensor diagnostic module 144, in one or more examples. The oxygen sensor diagnostic module 144 performs the oxygen sensor diagnostic described herein. It should be noted that the oxygen sensor signals from oxygen sensors 152 and 154 are the inputs to the closed loop fuel control module 142 to adjust the air-fuel ratio, to control emission(s) of the engine 110. The oxygen sensor diagnostic is to ensure the validity of the signals so as to meet the government regulation requirements.

The processing unit 140, based on the closed loop fuel control determines an air fuel ratio for the engine 110 and controls the actuators 130 to inject a corresponding amount of air and/or air-fuel mixture 105 into the engine 110. The engine 110 generates exhaust gases 115 that are received and processed by the exhaust system 120 to reduce emissions. The exhaust gases 115 are then released into the atmosphere.

The closed loop fuel control for determining the air-fuel mixture 105 that is injected into the engine 110 is performed based on one or more sensor measurements including measurements from the oxygen sensors 152 and 154. In one or more examples, the oxygen sensors include a front oxygen sensor 152 and a rear oxygen sensor 154. The front oxygen sensor 152 is upstream of the catalyst device 125 and the rear oxygen sensor 154 is downstream of the catalyst device 125. It should be noted that the vehicle 10 can include additional sensors, such as an air flow sensor 170, an accelerator pedal sensor 160 that detects if an acceleration maneuver is being requested by an operator of the vehicle 10. If so, the air-fuel ratio in the air-fuel mixture 105 being injected into the engine 110 may be increased after a deceleration fuel cut-off (DFCO) event.

The processing unit 140 is responsible for performing on board diagnostic processes for the various sensors. In particular, with respect to the performance of an oxygen sensor, which can be used to determine the proper air fuel ratio of the engine 110, various oxygen sensor diagnostic methods are known. For example, it is known to perturb or vary the air fuel ratio two times during vehicle deceleration (i.e., a first intrusive event, and a second intrusive event), and then sense the voltage output of an exhaust gas oxygen sensor corresponding to the two intrusive events. The two oxygen sensor measurements are then used to determine if an oxygen sensor 152 or 154 has developed a fault/error and an operator of the vehicle 10 is notified in case of an error, in one or more examples.

Such a perturbation is an intrusive task and may have undesirable side effects. For example, the perturbation interrupts DFCO operation. Further, the perturbation results in a reduction in fuel efficiency and has a negative impact on drive quality during vehicle deceleration. The technical solutions described herein address such technical challenges by eliminating the need for a fuel enrichment event to be performed for the oxygen sensor diagnostic. Accordingly, emissions, such as CO2 emissions are improved. Further, the DFCO is not interrupted leading to an improved drive quality. The technical solutions described herein accordingly facilitate an improvement of oxygen sensor diagnostic performed by the vehicle 10, which in turn improves performance of the vehicle 10.

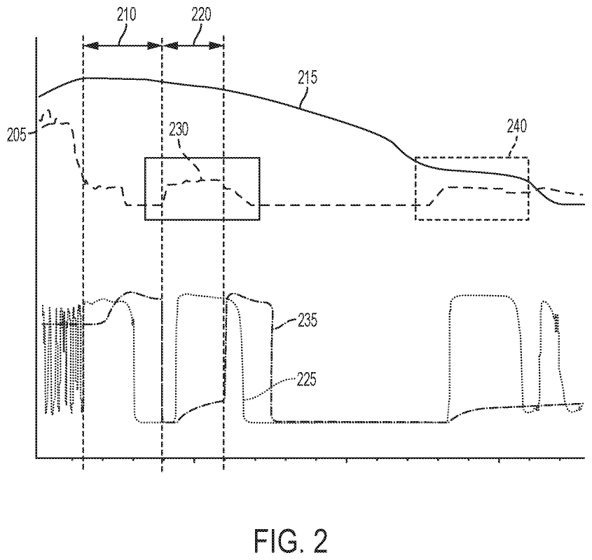

FIG. 2 depicts an existing oxygen sensor diagnostic that includes two intrusive test events, a first intrusive test 210 and a second intrusive test 220. The first intrusive test 210 is performed when a vehicle deceleration event is detected, and is referred to as a rich-to-lean intrusive test. Further, the second intrusive test 220 is performed immediately following the first intrusive test, and is referred to as a lean-to-rich intrusive test.

Graphs for fuel flow 205 and a vehicle speed 215, respectively, during the oxygen sensor diagnostic, are also shown in FIG. 2. Further, a front oxygen measurement graph 225 and a rear oxygen measurement graph 235 are shown in FIG. 2 to represent the measurements from the front oxygen sensor 152 and the rear oxygen sensor 154, respectively. The oxygen sensor measurements during the period of the first intrusive test 210 and the period of the second intrusive test 220 are analyzed using known diagnostic techniques for the rich-to-lean diagnostic and the lean-to-rich diagnostic, respectively. The result of the two diagnostics, the rich-to-lean diagnostic and the lean-to-rich diagnostic, are used to determine whether the oxygen sensors have developed a fault. As can be seen, a DFCO event is interrupted to perform the second intrusive test 220 (vehicle 10 is decelerating as shown by graph of the vehicle speed 215). Further, a fuel injection 230 is performed for the second intrusive test 220. Therefore, as described herein, the performance of the engine 110 can be degraded by the oxygen sensor diagnostic performed in this manner.

FIG. 2 further depicts a fuel enrichment event 240 that is occurs during a catalyst oxygen storage control (COSC). The technical solutions described herein, use the COSC event 240 to execute the lean-to-rich performance diagnostic, instead of the second intrusive test 220. The COSC event 240 can be detected using an accelerator pedal sensor 160 (FIG. 1), an air flow sensor 170 or other known techniques. For example, when the operator pushes the accelerator pedal of the vehicle, the accelerator pedal sensor 160 indicates occurrence of a rich fuel event after an engine DFCO event. Alternatively, or in addition, the COSC event 240 can be detected using the air flow sensor 170. Detecting the COSC event using the one or more sensor measurements/signals can be performed using known techniques.

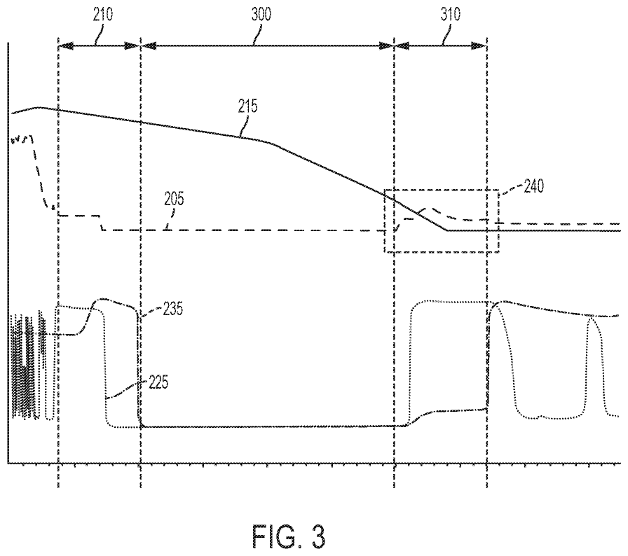

FIG. 3 depicts an oxygen sensor diagnostic according to one or more embodiments. The first intrusive test 210 is performed as described above for performing the rich-to-lean diagnostic. However, the second intrusive test is not performed immediately, and instead, a passive test 310 is performed for the lean-to-rich diagnostic when a COSC event 240 is detected. The oxygen sensor diagnostic module 144 performs the oxygen sensor diagnostic with the first intrusive test 210 followed by the passive test 310, in between is a vehicle deceleration period 300 that is controlled by the vehicle operator. For example, the COSC event 240 may be caused by the operator pushing the accelerator pedal, or increased torque request by The processing unit 140, or when the DFCO event ends, the processing unit 140 may perform the COSC event 240 for adjusting an amount of oxygen stored by the catalyst device 125. An automated torque increase request may be received, for example when the processing unit 140, during cruise control, requests additional torque to increase vehicle speed (without the driver using the gas pedal or any other method for requesting torque). By removing the second fuel enrichment event that was required for performing the second intrusive test 220, the DFCO is not interrupted, thus improving the performance of the engine 110.

The first intrusive test 210 for the rich-to-lean diagnostic and the passive test 310 for the lean-to-rich diagnostic can be executed on separate deceleration events instead of being bundled together (FIG. 2). This reduces possibility of re-running the entire diagnostic with the two tests in case the lean-to-rich diagnostic is aborted, for example by low catalyst temperature or low vehicle speed or high air flow rate or other pre-determined conditions. The results of the first intrusive test 210 can be independently performed with respect to the passive test 310.

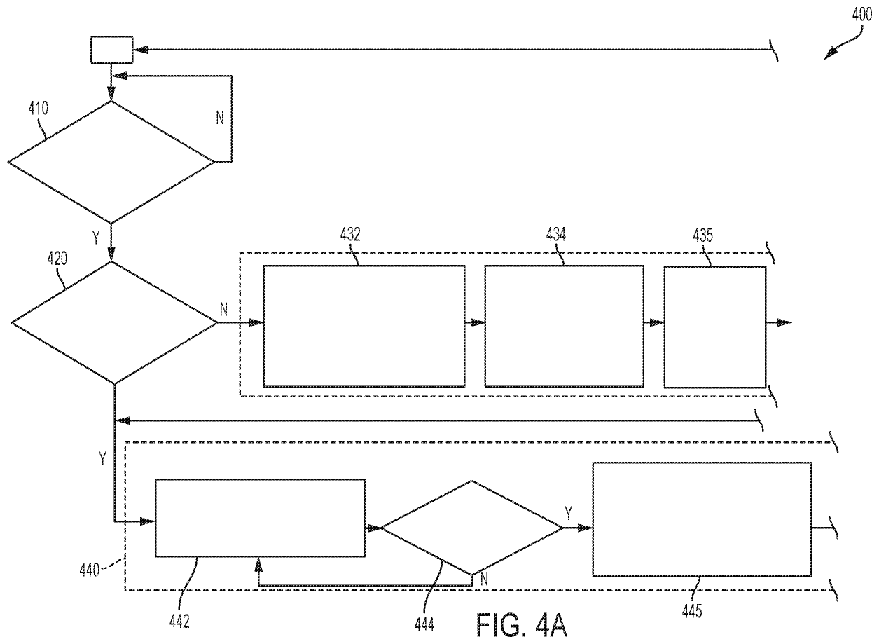

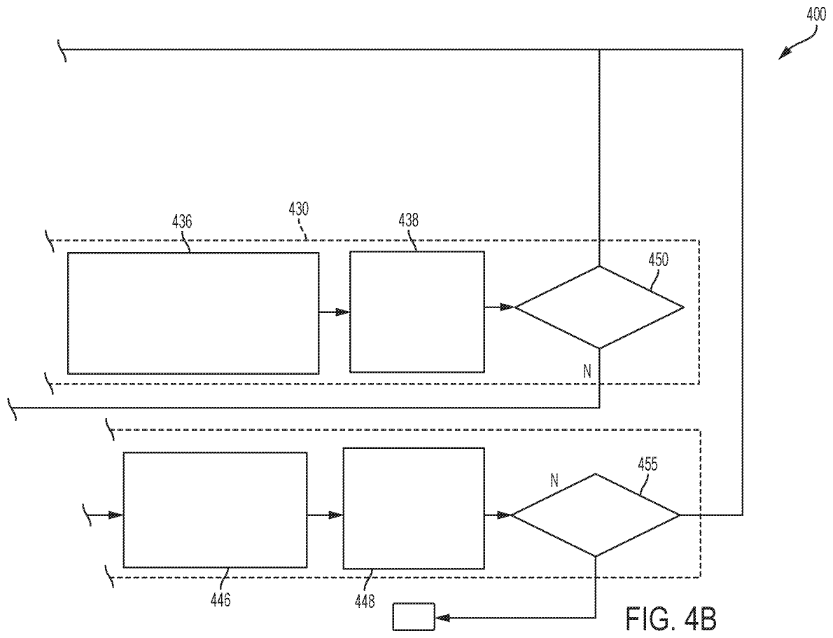

FIG. 4A and FIG. 4B depict a flowchart of a method 400 for performing an oxygen sensor diagnostic according to one or more embodiments; the diagnostic including a first intrusive test and a second passive (non-intrusive) test. The method 400 is attempted to run once per key-cycle of the vehicle 10 once predetermined conditions are met. The conditions can include particular temperature level of the exhaust flow, particular air-fuel ration, particular vehicle speed, particular vehicle deceleration, and the like.

The method 400 includes determining if an oxygen sensor diagnostic test, that is either the first intrusive test 210 or the passive test 310, can be performed, at 410. The determination includes detecting if the vehicle 10 is in deceleration, and if other such diagnostic conditions are met. The deceleration can be detected by monitoring the air flow rate and acceleration pedal position, using one or more sensors. Other known techniques can also be used to detect vehicle deceleration. The other conditions that may be used to initiate the oxygen sensor diagnostic test can include a temperature of the catalyst device 125, of the exhaust gases 115, or of any other component. Additional conditions may be monitored to determine if the oxygen sensor diagnostic test can be initiated. Until the conditions are met, the processing unit 140 waits to perform the oxygen sensor diagnostic. It should be noted that the passive test 310 is not performed unless the first intrusive test 210 is completed, as is described further.

Once the diagnostic conditions are met, the method 400 further includes determining if the first intrusive test 210 can be skipped, at 420. The first intrusive test 210 can be skipped only if the first intrusive test 210 has already been completed. This case can happen if the first intrusive test 210 or the passive test 310 is aborted, at 450 and 455. The tests can be aborted because of low catalyst temperature, low vehicle speed, or other such predetermined conditions. If the first intrusive test 210 is aborted (450), the method 400 is repeated and during a subsequent execution of the method 400, the first intrusive test 210 is initiated again. Alternatively, if the first intrusive test 210 completes (not aborted), and if the passive test 310 is aborted (455), during the subsequent execution of the method 400, the first intrusive test 210 is skipped. It should be noted that, as depicted, the first intrusive test 210 and the passive test 310 include multiple operations, and that the tests may abort (450/455) during any of the one or more operations. Unless the first intrusive test 210 is aborted (at 450), the first intrusive test 210 continues to be performed until it completes, at 438; and similarly, unless the passive test 310 is aborted (at 455), the passive test 310 continues to be performed until it completes, at 448.

The first intrusive test 210 includes sending one or more instructions/requests to corresponding components, at 432. The requests include a request to inhibit the DFCO event that is ongoing because of the vehicle deceleration. The requests further include locking a torque converter. Further, a request is sent to cause fuel enrichment. The first intrusive test 210 further includes performing a rich voltage test of the rear oxygen sensor 154, at 434.

Further, a DFCO event is requested, at 435. The first intrusive test 210 further includes checking various parameters to determine if the oxygen sensors 152 and 154 have developed a fault, at 436. If the oxygen at the front oxygen sensor 152 is rich (measurement signal above a predetermined threshold) the rich-to-lean test is performed for both the front and the rear oxygen sensors 152, 154. In one or more examples, the processing unit 140 also performs a catalyst diagnostic for testing the catalyst device 125. Further, a lean voltage test is performed for the rear oxygen sensor 154. Once the first intrusive test 210 is completed, all requests by the oxygen sensor diagnostic module 144 are removed from the control module 142 and the oxygen sensor diagnostic module 144 marks the first intrusive test 210 as being completed during the present key-cycle, at 438.

The method 400 further includes executing the passive test 310, at 440. Executing the passive test 310 includes passively monitoring the system to meet diagnostic conditions, at 442. The processing unit 140 monitors if a diagnostic condition occurs to initiate the lean-to-rich diagnostic, at 444. The diagnostic condition is represented by the COSC event 240 (FIG. 2). For example, the diagnostic condition that is detected includes an operator pushing the accelerator pedal, or an increased torque request by the system, or the DFCO ending, and the like. Such a condition is detected based on signals the one or more sensors, such as the accelerator pedal sensor 160, the air flow sensor 170, and the like.

Further, the passive test 310 includes commanding additional fuel enrichment if needed, on top of catalyst oxygen storage control, at 445. For example, the amount of fuel that is injected is measured and if the amount of fuel is less than a predetermined threshold, additional fuel is injected to bring the total amount of fuel injected to at least the predetermined threshold.

The method further includes performing the lean-to-rich diagnostic using the oxygen sensor measurements, at 446. The diagnostic is performed for both the front and the rear oxygen sensors 152, 154. The diagnostic includes comparing the oxygen sensor measurements with predetermined values. If the measurement values from the oxygen sensors 152, 154 not substantially match the corresponding predetermined values, the oxygen sensors 152, 154 are considered to be faulty. In one or more examples, a notification is generated and provided to the operator of the vehicle 10. For example, the notification may include an on-board diagnostic (OBD) code identifying the faulty oxygen sensors 152, 154. Once the passive test 310 is completed, all requests by the oxygen sensor diagnostic module 144 are removed and the oxygen sensor diagnostic module 144 marks the oxygen sensor diagnostic, which includes the first intrusive test and the passive test 310, as being completed during the present key-cycle, at 448.

The technical solutions described herein provide an OBD compliant oxygen sensor diagnostic method that reduces CO₂ emissions for internal combustion engines. The technical solutions described herein remove one of the at least two intrusive fuel enrichment events that are typically performed for on-board oxygen sensor diagnostics, and instead utilize an existing fuel enrichment event, such as for COSC to perform a passive oxygen sensor diagnostic. By removing the second intrusive fuel enrichment event, CO₂ emissions are improved (reduced). Further, by removing the second intrusive fuel enrichment event, a DFCO is not interrupted, thus improving drive quality. Further, a first intrusive part of the diagnostic can be executed on separate deceleration event from the passive part of the diagnostic reducing possibility to re-run the entire diagnostic, which was the case with the existing diagnostic, which always bundled the first intrusive test 210 and the second intrusive test 220 together. Additionally the technical solutions described herein eliminates a negative drive quality impact during the diagnostic execution. The technical solutions described herein thus addresses the technical challenges with existing on-board oxygen sensor diagnostics by producing measurable impacts on CO₂ emissions, fuel economy, and drive quality during vehicle deceleration.

It should be noted that the technical solutions herein can be performed for a gasoline based internal combustion engine, or for other substitute fuel like E85 with an exhaust system emission control devices including oxygen sensors as is described herein.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A control system in a motor vehicle including an internal combustion engine, the control system comprising:
an oxygen sensor; and
an oxygen sensor diagnosis module configured to diagnose the oxygen sensor, the oxygen sensor diagnosis comprising:
performing an intrusive rich-to-lean diagnostic for the oxygen sensor; and
detecting a lean-to-rich diagnostic event, and in response, performing a passive lean-to-rich diagnostic for the oxygen sensor, the lean-to-rich diagnostic event comprising a fuel enrichment.

2. The control system of claim 1, wherein the lean-to-rich event is caused by a catalyst oxygen storage control for a catalyst in an exhaust system of the internal combustion engine.

3. The control system of claim 1, wherein the lean-to-rich event is caused by at least one event from a group of events comprising an accelerator pedal being pushed by an operator of the motor vehicle, an automated increased torque request, and the engine exiting a deceleration fuel cut-off condition.

4. The control system of claim 1, wherein the passive lean-to-rich diagnostic further comprises:
determining an amount of fuel injected during the lean-to-rich event; and
in response to the amount of fuel being less than or equal to a predetermined threshold, injecting an additional amount of fuel to at least meet the predetermined threshold.

5. The control system of claim 1, wherein the intrusive rich-to-lean diagnostic is performed when a first deceleration of the motor vehicle is detected, and the passive lean-to-rich diagnostic is performed when a second deceleration of the motor vehicle is detected.

6. The control system of claim 1, wherein the oxygen sensor is upstream of a catalyst in an exhaust system of the motor vehicle.

7. The control system of claim 1, wherein the oxygen sensor is downstream of a catalyst in an exhaust system of the motor vehicle.

8. An on-board oxygen sensor diagnostic apparatus for an internal combustion engine, the on-board oxygen sensor diagnostic apparatus comprising:
a controller configured to diagnose one or more oxygen sensors, the oxygen sensor diagnosis comprising:
performing an intrusive rich-to-lean diagnostic for the one or more oxygen sensors; and
detecting a lean-to-rich diagnostic event, and in response, performing a passive lean-to-rich diagnostic for the one or more oxygen sensors, the lean-to-rich diagnostic event comprising a fuel enrichment.

9. The on-board oxygen sensor diagnostic apparatus of claim 8, wherein the lean-to-rich event is caused by a catalyst oxygen storage control for a catalyst in an exhaust system for the internal combustion engine.

10. The on-board oxygen sensor diagnostic apparatus of claim 8, wherein the lean-to-rich event is caused by at least one event from a group of events comprising an accelerator pedal being pushed by an operator of a motor vehicle, an automated increased torque request, and the engine exiting a deceleration fuel cut-off condition.

11. The on-board oxygen sensor diagnostic apparatus of claim 8, wherein the passive lean-to-rich diagnostic further comprises:
determining an amount of fuel injected during the lean-to-rich event; and
in response to the amount of fuel being less than or equal to a predetermined threshold, injecting an additional amount of fuel to at least meet the predetermined threshold.

12. The on-board oxygen sensor diagnostic apparatus of claim 8, wherein the intrusive rich-to-lean diagnostic is performed when a first deceleration of a motor vehicle is detected, and the passive lean-to-rich diagnostic is performed when a second deceleration of the motor vehicle is detected.

13. The on-board oxygen sensor diagnostic apparatus of claim 12, wherein the oxygen sensors include a first oxygen sensor that is upstream of a catalyst in an exhaust system.

14. The on-board oxygen sensor diagnostic apparatus of claim 13, wherein the oxygen sensors include a second oxygen sensor that is downstream of a catalyst in an exhaust system.

15. A computer-implemented method for diagnosing one or more oxygen sensors in an exhaust system of an internal combustion engine in a motor vehicle, the method comprising:
performing an intrusive rich-to-lean diagnostic for the oxygen sensor; and
detecting a lean-to-rich diagnostic event, and in response, performing a passive lean-to-rich diagnostic for the oxygen sensor, the lean-to-rich diagnostic event comprising a fuel enrichment.

16. The method of claim 15, wherein the lean-to-rich event is caused by a catalyst oxygen storage control for a catalyst in an exhaust system of the internal combustion engine.

17. The method of claim 15, wherein the lean-to-rich event is caused by at least one event from a group of events comprising an accelerator pedal being pushed by an operator of a motor vehicle, an automated increased torque request, and the engine exiting a deceleration fuel cut-off condition.

18. The method of claim 15, wherein the passive lean-to-rich diagnostic further comprises:
determining an amount of fuel injected during the lean-to-rich event; and
in response to the amount of fuel being less than or equal to a predetermined threshold, injecting an additional amount of fuel to at least meet the predetermined threshold.

19. The method of claim 18, wherein the intrusive rich-to-lean diagnostic is performed when a first deceleration of the motor vehicle is detected, and the passive lean-to-rich diagnostic is performed when a second deceleration of the motor vehicle is detected.

20. The method of claim 19, wherein the oxygen sensors include a first oxygen sensor that is upstream of a catalyst in an exhaust system, and a second oxygen sensor that is downstream of a catalyst in an exhaust system.
